(19) United States
(12) Patent Application Publication
(10) Pub. No.: US 2026/0043688 A1
(43) Pub. Date: Feb. 12, 2026

(54) TWO-COLOR THERMOMETER, LASER SYSTEM, AND TEMPERATURE MEASUREMENT METHOD

(71) Applicant: Panasonic Intellectual Property Management Co., Ltd., Osaka (JP)

(72) Inventors: Tsuyoshi NAGATA, Fukuoka (JP); Masashi FUMIYAMA, Osaka (JP); Kazuyuki INOUE, Osaka (JP)

(21) Appl. No.: 19/290,705

(22) Filed: Aug. 5, 2025

(30) Foreign Application Priority Data
Aug. 9, 2024 (JP) 2024-133764

(51) Int. Cl. G01J 5/60

(52) U.S. Cl. CPC G01J 5/60; G01J 2005/607

(57) ABSTRACT

A two-color thermometer includes: a first sensor that detects a first intensity that is an intensity of first infrared radiation emitted by an object; a second sensor that detects a second intensity that is an intensity of second infrared radiation emitted by the object at a wavelength different from a wavelength of the first infrared radiation; and a temperature calculator that calculates a first coefficient by inputting, into a correction function, a second coefficient calculated from the first intensity detected by the first sensor and the second intensity detected by the second sensor, and calculates a temperature of the object based on the first coefficient calculated and an intensity ratio between the first intensity and the second intensity. The correction function is calculated from a first correction coefficient and a second correction coefficient that are calculated in advance from a measured temperature of each of different materials.

### CROSS REFERENCE TO RELATED APPLICATION

The present application is based on and claims priority of Japanese Patent Application No. 2024-133764 filed on Aug. 9, 2024. The entire disclosure of the above-identified application, including the specification, drawings and claims is incorporated herein by reference in its entirety.

### FIELD

The present disclosure relates to a two-color thermometer, a laser system including the two-color thermometer, and a temperature measurement method.

### BACKGROUND

A technique for measuring a temperature of an object to be measured based on infrared radiation emitted by the object to be measured has been known. In this case, when the temperature of the object to be measured is calculated only from the intensity of the infrared radiation at a single wavelength, the emissivity of the object to be measured is required. It has been known that the emissivity of the object to be measured is not required theoretically for a two-color thermometer that calculates a temperature of the object to be measured from an intensity ratio between intensities of infrared radiation of two different wavelengths emitted from the object to be measured. However, an error may occur in the temperature calculated by the two-color thermometer. More specifically, the emissivity of a gray body is constant regardless of wavelengths and is smaller than one, but the emissivity of a general substance (e.g., metal) tends to be lower as the wavelength becomes longer. Therefore, the two-color thermometer that uses a ratio between two wavelengths may cause an error.

As a two-color thermometer of this type, Patent Literature (PTL) 1 discloses a temperature measurement module that includes: a first infrared sensor that measures infrared radiation emitted by an object to be measured; a second infrared sensor that measures infrared radiation in a wavelength range longer than a wavelength range measured by the first infrared sensor; a first temperature detection means that detects a temperature of the object to be measured based on an intensity ratio between an intensity of the infrared radiation measured by the first infrared sensor and an intensity of the infrared radiation measured by the second infrared sensor; a second temperature detection means that detects a temperature of the object to be measured based on the intensity of the infrared radiation measured by the second infrared sensor; and a comparison means that compares temperature data output by the first temperature detection means and temperature data output by the second temperature detection means, and outputs higher temperature data.

### CITATION LIST

### Patent Literature

PTL 1: Japanese Unexamined Patent Application Publication No. 2007-10421

### SUMMARY

### Technical Problem

However, when the temperature of the object to be measured is calculated using only an intensity ratio between the intensities of infrared radiation at two different wavelengths, an error may occur in the temperature due to a difference in property of the object (material) to be measured. Furthermore, the error itself due to the measurement may differ depending on conditions (such as distance and wavelength). In other words, as in the method disclosed in PTL 1, even when a temperature considered to have a smaller error (i.e., a higher temperature) is used, a potential error due to difference in property of materials cannot be eradicated.

Moreover, as described above, the emissivity of a gray body is constant regardless of wavelengths, and thus the intensity ratio of a gray body between infrared radiation at two different wavelengths is also constant. However, regarding a metal, the emissivity is lower as the wavelength becomes longer, and the dependency of the emissivity on the wavelength differs according to the types of metals. Therefore, the intensity ratio between the intensities of infrared radiation at two different wavelengths may differ according to a combination of infrared radiation at two different wavelengths or the types of metals. As a result, the calculated temperature may include an error.

The present disclosure is to solve such a problem, and aims to provide a two-color thermometer, a laser system, and a temperature measurement method that can measure a temperature of an object with high accuracy.

### Solution to Problem

In order to achieve the above, a two-color thermometer according to the present disclosure includes: a first sensor that detects a first intensity that is an intensity of first infrared radiation emitted by an object; a second sensor that detects a second intensity that is an intensity of second infrared radiation emitted by the object at a wavelength different from a wavelength of the first infrared radiation; and a temperature calculator that calculates a first coefficient by inputting, into a correction function, a second coefficient calculated from the first intensity detected by the first sensor and the second intensity detected by the second sensor, and calculates a temperature of the object based on the first coefficient calculated and an intensity ratio between the first intensity detected by the first sensor and the second intensity detected by the second sensor. The correction function is calculated from a first correction coefficient calculated in advance from a measured temperature of each of a plurality of different materials and a second correction coefficient calculated in advance from the measured temperature of each of the plurality of different materials.

Moreover, a laser system according to the present disclosure includes: a laser device that outputs a laser beam to irradiate an object with the laser beam; and the two-color thermometer described above. The two-color thermometer measures a temperature of the object.

Moreover, a temperature measurement method according to the present disclosure is a temperature measurement method of measuring a temperature of an object that emits first infrared radiation and second infrared radiation at a wavelength different from a wavelength of the first infrared radiation. The temperature measurement method includes: calculating a first coefficient by inputting, into a correction function, a second coefficient calculated from a first intensity that is an intensity of the first infrared radiation detected by a first sensor and a second intensity that is an intensity of the second infrared radiation detected by a second sensor, and calculating the temperature of the object based on the first coefficient calculated and an intensity ratio between the first intensity detected by the first sensor and the second intensity detected by the second sensor. The correction function is calculated from a first correction coefficient calculated in advance from a measured temperature of each of a plurality of different materials and a second correction coefficient calculated in advance from the measured temperature of each of the plurality of different materials.

### Advantageous Effects

The present disclosure can measure a temperature of an object with high accuracy.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a configuration of a laser system according to an embodiment.

FIG. 2 is a graph illustrating a relationship between a temperature and an intensity ratio between intensities of infrared radiation at two different wavelengths emitted from a black body.

FIG. 3 is a graph illustrating a relationship between the intensities of the infrared radiation at two different wavelengths emitted from the material used in FIG. 2.

FIG. 4A is a graph illustrating a relationship between a temperature and an intensity ratio between intensities of infrared radiation at two different wavelengths regarding material a.

FIG. 4B is a graph illustrating a relationship between a temperature and an intensity ratio between intensities of infrared radiation at two different wavelengths regarding material b.

FIG. 4C is a graph illustrating a relationship between a temperature and an intensity ratio between intensities of infrared radiation at two different wavelengths regarding material c.

FIG. 5A is a graph illustrating a relationship between intensities of infrared radiation at two different wavelengths regarding material a.

FIG. 5B is a graph illustrating a relationship between intensities of infrared radiation at two different wavelengths regarding material b.

FIG. 5C is a graph illustrating a relationship between intensities of infrared radiation at two different wavelengths regarding material C.

FIG. 6 is a graph illustrating a when a is fixed regardless of a value of β.

FIG. 7 is a graph illustrating a correction function when a plurality of points of combinations of correction coefficients α and β are approximated by a quadratic function.

FIG. 8 is a graph illustrating a relationship between measured temperatures and calculated temperatures when a is fixed.

FIG. 9 is a graph illustrating a relationship between measured temperatures and calculated temperatures when the correction function is a quadratic function.

FIG. 10 is a graph illustrating a relationship between a temperature and an intensity ratio of a combination of infrared radiation at two different wavelengths different from the wavelengths in FIG. 2.

FIG. 11 is a graph illustrating a relationship between the intensities of infrared radiation at two different wavelengths emitted from the material used in FIG. 10.

### DESCRIPTION OF EMBODIMENT

Hereinafter, one or more specific embodiments are described with reference to the accompanying Drawings. Note that each of the one or more embodiments described below shows a general or specific example of the present disclosure. Therefore, the numerical values, shapes, materials, structural elements, the arrangement and connection of the structural elements, steps and the processing order of the steps, etc. shown in the following one or more embodiments are mere examples, and therefore are not intended to limit the scope of the present disclosure. Therefore, among the structural elements in the following one or more embodiments, those not recited in any one of the independent claims are described as optional structural elements.

Moreover, the drawings are schematic diagrams, and are not necessarily precise depictions. Moreover, in the drawings, the same reference numerals are given to substantially similar configurations, and repeated description thereof may be omitted or simplified.

### EMBODIMENT

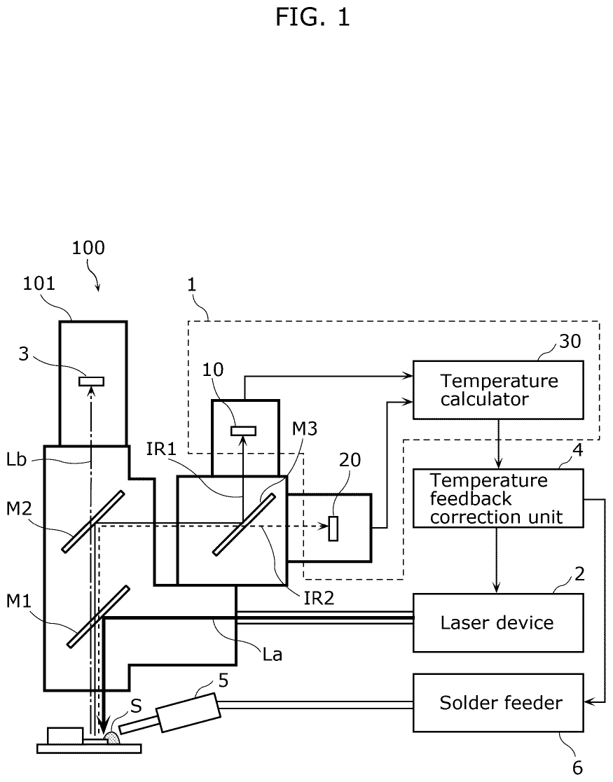

First, a configuration of laser system 100 according to an embodiment will be described with reference to FIG. 1. FIG. 1 is a diagram illustrating a configuration of laser system 100 according to an embodiment.

As illustrated in FIG. 1, laser system 100 includes two-color thermometer 1 that measures a temperature of object S and laser device 2 that outputs laser beam La to irradiate object S.

Two-color thermometer 1 is a two-color radiation temperature sensor that measures a temperature by detecting infrared radiation at two different wavelengths at different wavelengths. In laser system 100, two-color thermometer 1 measures a temperature of object S when irradiating object S with a laser beam. In other words, object S is an object whose temperature is to be measured by two-color thermometer 1.

Two-color thermometer 1 includes first sensor 10 and second sensor 20 that detect infrared radiation, and temperature calculator 30.

First sensor 10 is an infrared sensor that detects a first intensity, which is an intensity of first infrared radiation IR1 emitted by object S. First infrared radiation IR1 emitted by object S (the solid line in FIG. 1) passes through first wavelength selection filter M1, is reflected off second wavelength selection filter M2, is reflected off third wavelength selection filter M3, and is incident on first sensor 10. An example of second wavelength selection filter M2 and third wavelength selection filter M3 is a longpass filter (LPF).

An example of the wavelength range of first infrared radiation IR1 to be detected by first sensor 10 is from 0.9 μm to 2.55 μm. First sensor 10 is a photodiode capable of detecting an intensity of infrared radiation, for example. In this case, first sensor 10 can detect an intensity of infrared radiation as a voltage value. In the present embodiment, InGaAs PIN photodiode is used as first sensor 10. Note that first sensor 10 should not be construed to be limited to a photodiode. For example, first sensor 10 may be other sensors such as a thermopile infrared sensor or the like.

Second sensor 20 is an infrared sensor that detects a second intensity, which is an intensity of second infrared radiation IR2 emitted by object S. Wavelength λ2 of second infrared radiation IR2 and wavelength λ1 of first infrared radiation IR1 are different (λ1≠λ2). In the present embodiment, wavelength λ2 of second infrared radiation IR2 to be detected by second sensor 20 is longer than wavelength λ1 of first infrared radiation IR1 to be detected by first sensor 10 (λ2>λ1). Second infrared radiation IR2 (dashed line in FIG. 1) emitted by object S passes through first wavelength selection filter M1, is reflected off second wavelength selection filter M2, passes through third wavelength selection filter M3, and is incident on second sensor 20.

An example of the wavelength range of second infrared radiation IR2 to be detected by second sensor 20 is from 2 μm to 5 μm. Second sensor 20 is an InAsSb photovoltaic element capable of detecting an intensity of infrared radiation, for example. In this case, second sensor 20 can detect an intensity of infrared radiation as a voltage value. Note that second sensor 20 should not be construed to be limited to an InAsSb photovoltaic element.

Temperature calculator 30 calculates a temperature of object S based on a first intensity of first infrared radiation IR1 detected by first sensor 10 and a second intensity of second infrared radiation IR2 detected by second sensor 20. More specifically, temperature calculator 30 calculates a temperature of object S using a correction function. Details of the temperature calculation method by temperature calculator 30 will be described later. Note that temperature calculator 30 includes a processor (CPU), memory, a circuit, and so on.

Laser device 2 is, for example, a laser oscillator, and includes a semiconductor laser element that emits a laser beam. When predetermined electric power is supplied to the semiconductor laser element, laser device 2 outputs laser beam La at a predetermined wavelength. Laser beam La emitted from laser device 2 is reflected off first wavelength selection filter M1 and irradiates object S. In the present embodiment, laser device 2 and two-color thermometer 1 are disposed optically coaxially.

Moreover, laser system 100 is configured such that object S can be observed. More specifically, laser system 100 includes an observation camera including imaging element 3 capable of capturing visible light. Visible light Lb (dash-dot line in FIG. 1) around object S passes through first wavelength selection filter M1, passes through second wavelength selection filter M2, and is incident on imaging element 3. With this, imaging element 3 can obtain a surrounding image of object S.

In the present embodiment, laser system 100 includes two-color thermometer optical coaxial lens barrel 101. As illustrated in FIG. 1, two-color thermometer optical coaxial lens barrel 101 includes first sensor 10, second sensor 20, imaging element 3, first wavelength selection filter M1, second wavelength selection filter M2, and third wavelength selection filter M3. More specifically, first sensor 10, second sensor 20, imaging element 3, first wavelength selection filter M1, second wavelength selection filter M2, and third wavelength selection filter M3 are within the casing that is included in two-color thermometer optical coaxial lens barrel 101.

Note that in FIG. 1, among first sensor 10, second sensor 20, and temperature calculator 30 in two-color thermometer 1, first sensor 10 and second sensor 20 are within two-color thermometer optical coaxial lens barrel 101 and temperature calculator 30 is not within two-color thermometer optical coaxial lens barrel 101, but the present disclosure is not limited to this configuration. In other words, temperature calculator 30 may also be within two-color thermometer optical coaxial lens barrel 101. Note that when temperature calculator 30 is not within two-color thermometer optical coaxial lens barrel 101, temperature calculator 30 may be a computer or the like that is separate from two-color thermometer optical coaxial lens barrel 101.

Moreover, laser system 100 further includes temperature feedback correction unit 4. Temperature feedback correction unit 4 adjusts output of laser beam La based on the temperature of object S calculated by two-color thermometer 1. For example, temperature feedback correction unit 4 adjusts output of laser beam La by controlling electric power to be supplied to the semiconductor laser element in laser device 2 such that the temperature of object S calculated by two-color thermometer 1 falls within a predetermined range. With this, the temperature of object S can be adjusted to bring the temperature within a certain range.

An example of laser system 100 in the present embodiment is a laser soldering system or a laser soldering device that solders components together with a laser beam. In this case, object S is a component to be joined before solder is applied, and becomes solder after solder is applied. In other words, two-color thermometer 1 measures temperatures of different materials. Moreover, as illustrated in FIG. 1, laser system 100 includes feeder 5 including a nozzle and a motor for supplying solder, and solder feeder 6 that controls feeder 5. The solder feeding amount controlled by solder feeder 6 for feeder 5 may be controlled by temperature feedback correction unit 4. When laser system 100 is a laser soldering system or a laser soldering device, the wavelength of laser light La may be, for example, 980 nm, 940 nm, or 450 nm.

Note that laser system 100 should not be construed to be limited to a laser soldering system or a laser soldering device. For example, laser system 100 may be a laser processing system or a laser processing machine. In this case, object S is an object to be processed with laser beam La, and two-color thermometer 1 measures a temperature of the object to be processed, which is object S. An example of a laser processing system or a laser processing machine may be a laser welding system or a laser welding machine. In this case, object S is an object to be welded with laser beam La, and two-color thermometer 1 measures a temperature of object S to be weltered.

Next, features of two-color thermometer 1 in the present embodiment will be described. When a temperature is calculated from infrared radiation at two different wavelengths, two-color thermometer 1 in the present embodiment uses a correction function calculated in advance based on the measured temperatures. Hereinafter, a method of calculating this correction function and a temperature calculation method using the correction function will be described in detail.

First, a relationship between a temperature and an intensity ratio between the intensities of infrared radiation at two different wavelengths detected by two sensors will be described. Regarding black body radiation, an approximate equation of the temperature curve calculated from the intensity ratio between the intensities of infrared radiation at two different wavelengths detected by two sensors can be expressed as the following equation according to Planck's formula of radiation, where T (° C.) is a temperature, and Rate is an intensity ratio between the intensities of the infrared radiation at two different wavelengths. In other words, the approximate equation of the temperature curve is proportional to the 0.38th power of the intensity ratio between the intensities of the infrared radiation at two different wavelengths.

$$[ Math . 1 ]$$

$$T ( ° C . ) = A \times {( Rate )}^{0.38}$$

Note that in the above equation, among the infrared radiation at two different wavelengths, when the intensity of first infrared radiation at a shorter wavelength is I_{S}, the intensity of second infrared radiation at a longer wavelength is I_{L}, and the intensity ratio between the intensity of the first infrared radiation and the intensity of the second infrared radiation is Rate, Rate is expressed as the following equation.

$$[ Math . 2 ]$$

$$Rate = {I}_{S} / {I}_{L}$$

In the approximate equation of the temperature curve, A is a coefficient. In other words, the relationship between the temperature and the intensity ratio between the intensities of the infrared radiation at two different wavelengths differs according to a material to be irradiated with infrared radiation (i.e., coefficient A is different). Therefore, the temperature may be corrected by measuring a temperature and calculating coefficient A for each material to be measured.

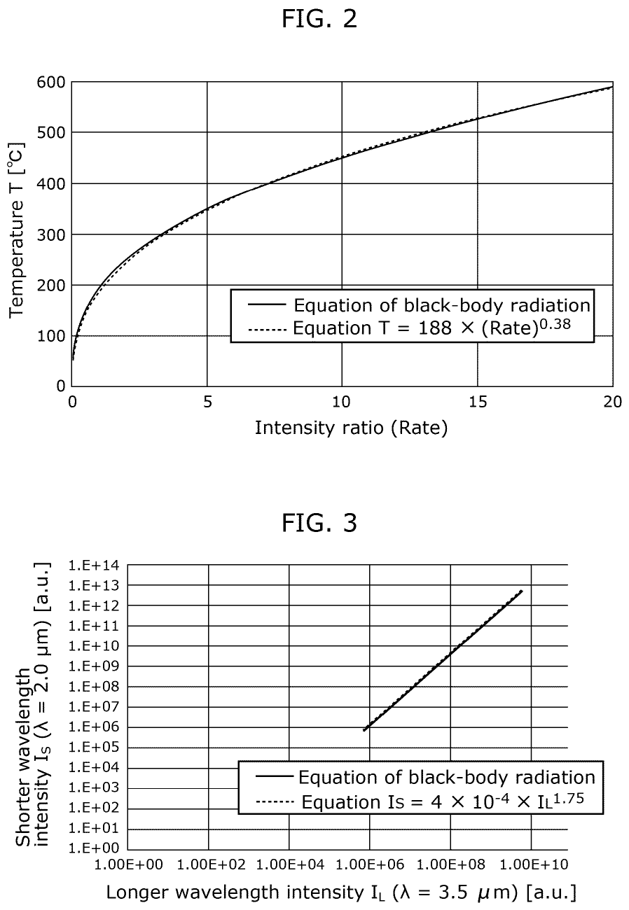

FIG. 2 illustrates a relationship between a temperature and an intensity ratio between intensities of the infrared radiation at two different wavelengths emitted from a black body. More specifically, FIG. 2 illustrates a relationship between a temperature and an intensity ratio of the intensity of infrared radiation at a wavelength around 2 μm and the intensity of infrared radiation at a wavelength around 3.5 μm.

In FIG. 2, the solid line represents the curved line obtained by calculating change in intensity between the wavelength of 2 μm and the wavelength of 3.5 μm at each temperature using the equation of black-body radiation. In FIG. 2, the dashed line represents the curved line assuming T (° C.)=A×(Rate)^{0.38}, where A=188. As can be seen from the figure, by setting coefficient A to 188, the resulting values can be approximated to the values obtained from the equation of black-body radiation. In other words, the approximate equation T (° C.)=A×(Rate)^{0.38} is valid. Accordingly, temperature T can be expressed as an exponential function of Rate, where A is used as a coefficient.

Next, a relationship between the intensities of the infrared radiation at two different wavelengths detected by two sensors will be described. When I_{S} is the intensity of first infrared radiation at a shorter wavelength among the infrared radiation at two different wavelengths and I_{L} is the intensity of second infrared radiation at a longer wavelength among the infrared radiation at two different wavelengths, I_{S} and I_{L} can be expressed by the following equation. More specifically, I_{S} is proportional to the 1.75th power of I_{L}. In the following approximate equation, B is a coefficient. Accordingly, I_{S} can be expressed as an exponential function of I_{L}, where B is used as a coefficient.

$$[ Math . 3 ]$$

$${I}_{S} = B \times {I}_{L}^{1.75}$$

As can be seen from the approximate equation, the relationship between the intensities of the infrared radiation at two different wavelengths differs according to a material to be irradiated with infrared radiation. In other words, coefficient B differs for each material. Therefore, the temperature may be corrected by measuring the temperature and calculating coefficient B for each material to be measured.

FIG. 3 illustrates a relationship between the intensities of the infrared radiation at two different wavelengths emitted from the material used in FIG. 2. More specifically, FIG. 3 illustrates a relationship between an intensity of infrared radiation at a wavelength of 2 μm (shorter wavelength intensity) and an intensity of infrared radiation at a wavelength of 3.5 μm (longer wavelength intensity).

In FIG. 3, the solid line represents a line obtained by calculating the intensity of the wavelength of 2 μm and the intensity of the wavelength of 3.5 μm from the equation of black-body radiation. In FIG. 3, the dashed line represents the curved line assuming I_{S}=B×I_{L}^{1.75}, where B=4×10⁻⁴. As can be seen from the figure, by setting coefficient B to 4×10⁻⁴, the resulting values can be approximated to the values obtained from the equation of black-body radiation. In other words, the approximate equation I_{S}=B×I_{L}^{1.75} is valid. Note that in this approximate equation, the multiplier (1.75) varies according to the wavelength band of infrared radiation to be used.

Based on the above knowledge, first, correction coefficients α and β to be used for two-color thermometer 1 in the present embodiment were calculated based on measured temperatures. Note that the temperatures were measured by a thermocouple. Moreover, the intensities of infrared radiation at two different wavelengths were measured using two-color thermometer optical coaxial lens barrel 101 in FIG. 1, but may be measured using a different device.

First, correction coefficient α (first correction coefficient) will be described. Correction coefficient α corresponds to coefficient A described above. Therefore, correction coefficient α, temperature T, and intensity ratio Rate (=I_{S}/I_{L}) of infrared radiation at two different wavelengths can be expressed by the approximate equation T (° C.)=α×(Rate)^{0.38}.

Furthermore, Rate was calculated for each of three materials (materials a, b, and c) whose Rate changes in a temperature range from 0 degrees Celsius to 600 degrees Celsius (more specifically, in a range from 0 degrees Celsius to 300 degrees Celsius) by detecting the intensity of each of the infrared radiation at two different wavelengths emitted by the materials at that time. In the present embodiment, three different actual temperature points were measured and intensity ratios Rate at that time were calculated for each of three materials. Moreover, the shorter wavelength among the infrared radiation at two different wavelengths to be detected was 2 μm, and the longer wavelength among the infrared radiation at two different wavelengths to be detected was 3.5 μm. Note that in the present embodiment, material a is black anodized aluminum, material b is solder, and material c is copper.

More specifically, first, for material a, correction coefficient α was calculated from the measurement results based on the approximate equation T (° C.)=α×(Rate)^{0.38}. In the present embodiment, as shown in the following equation, three different actual temperature points were measured, and α (α₁, α₂, α₃) were calculated for each material, and the average value of these values was calculated and used as α. As a result, α=167.

$${a}_{1} = {T}_{1} \div {( {Rate}_{1} )}^{0.38}$$

$${a}_{2} = {T}_{2} \div {( {Rate}_{2} )}^{0.38}$$

$${a}_{3} = {T}_{3} \div {( {Rate}_{3} )}^{0.38}$$

$$a = ( {a}_{1} + {a}_{2} + {a}_{3} ) \div 3$$

Moreover, correction coefficient α was also calculated in the same manner for material b and material c. As a result, correction coefficient α for material b was 173, and correction coefficient α for material c was 153.

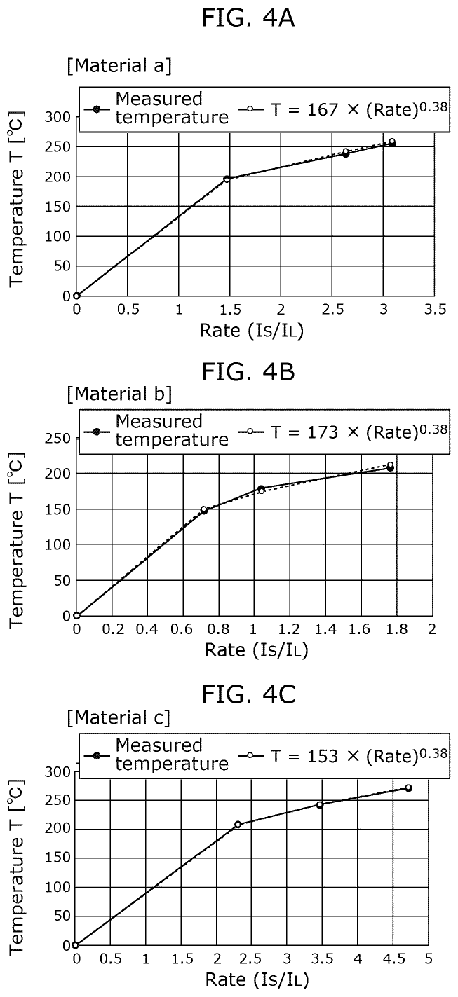

FIG. 4A, FIG. 4B, and FIG. 4C illustrate the results. For each material, three points were plotted for measured temperatures T (° C.) and intensity ratios Rate. Additionally, for each material, three points representing values obtained by substituting the corresponding intensity ratio Rate into the approximate equation in which the correction coefficient for that material was applied were plotted. FIG. 4A illustrates the result of material a (black anodized aluminum), FIG. 4B illustrates the result of material b (solder), and FIG. 4C illustrates the result of material c (copper). As can be seen from FIG. 4A, FIG. 4B, and FIG. 4C, the calculated correction coefficients α are valid.

Note that in the present embodiment, T (° C.)=α×(Rate)^{0.38} is used as an example of the approximate equation to calculate correction coefficient α, but the present disclosure should not be construed to be limited to this example. In other words, correction coefficient α may be calculated using a different approximate equation. Moreover, in the present embodiment, an average value of three points is used to calculate correction coefficient α, but the present disclosure should not be construed to be limited to this example. For example, correction coefficient α may be calculated from only one point, or an average value of two points or four or more points may be used as correction coefficient α.

Next, correction coefficient β (second correction coefficient) will be described. Correction coefficient β corresponds to coefficient B described above. Therefore, correction coefficient β and intensities I_{S} and I_{L} of the infrared radiation at two different wavelengths can be expressed by the approximate equation I_{S}=β×I_{L}^{1.75}.

Based on the intensities of the infrared radiation at the two wavelengths detected when correction coefficient α was calculated, correction coefficient β was calculated for each of material a, material b, and material c.

More specifically, first, for material a, correction coefficient β was calculated from the measurement results based on the approximate equation I_{S}=β×I_{L}^{1.75}. In the present embodiment, as shown in the following equation, since three different actual temperature points were measured, for each of the three points, β (β₁, β₂, β₃) was calculated, and the average value of these values was calculated and used as β. As a result, β=1.6.

$${β}_{1} = {I}_{S 1} \div {( {I}_{L 1} )}^{1.75}$$

$${β}_{2} = {I}_{S 1} \div {( {I}_{L 2} )}^{1.75}$$

$${β}_{3} = {I}_{S 1} \div {( {I}_{L 3} )}^{1.75}$$

$$β = ( {β}_{1} + {β}_{2} + {β}_{3} ) \div 3$$

Moreover, correction coefficient β was also calculated in the same manner for material b and material c. As a result, correction coefficient β for material b was 5.4, and correction coefficient β for material c was 18.7.

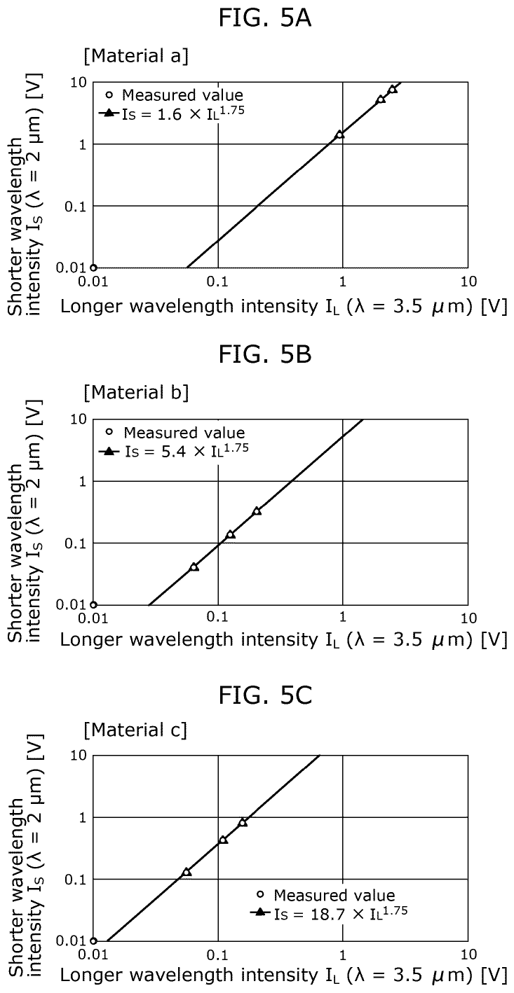

FIG. 5A, FIG. 5B, and FIG. 5C illustrate the results. For each material, three points were plotted for measured values of I_{S} and I_{L}. Additionally, for each material, three points of I_{S} obtained by substituting I_{L} into the approximate equation in which the correction coefficient for that material was applied were plotted. Note that, FIG. 5A illustrates the result of material a (black anodized aluminum), FIG. 5B illustrates the result of material b (solder), and FIG. 5C illustrates the result of material c (copper). As can be seen from FIG. 5A, FIG. 5B, and FIG. 5C, the calculated correction coefficients β are valid.

Note that in the present embodiment, I_{S}=β×I_{L}^{1.75} has been used as an example of the approximate equation to calculate correction coefficient β, but the present disclosure should not be construed to be limited to this example. In other words, correction coefficient β may be calculated using a different approximate equation. Moreover, in the present embodiment, an average value of three points has been used to calculate correction coefficient β, but the present disclosure should not be constructed to be limited to this example. For example, correction coefficient β may be calculated from only one point, or an average value of two points or four or more points may be used as correction coefficient β.

Next, the calculated correction coefficients α and β are used to determine a correction function to be used to calculate a temperature by temperature calculator 30.

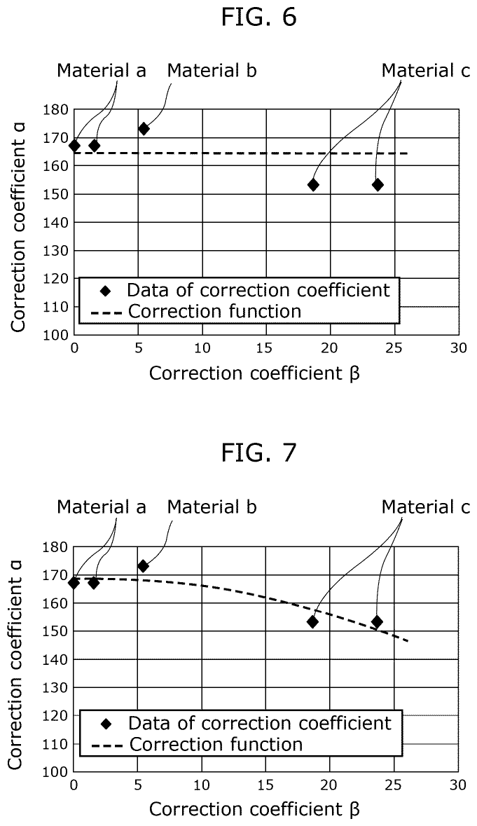

More specifically, at least one combination of correction coefficient α and correction coefficient β for each of material a, material b, and material c is plotted in a two-dimensional Cartesian coordinate system. In the present embodiment, as illustrated in FIG. 6 and FIG. 7, for material a, two combinations of correction coefficients α and β are calculated and two points corresponding to the two combinations are plotted. For material b, one combination of correction coefficients α and β is calculated and one point corresponding to the one combination is plotted. For material c, two combinations of correction coefficients α and β are calculated and two points corresponding to the two combinations are plotted.

An approximate equation is determined for the plurality of points corresponding to the combinations of correction coefficients α and β plotted in the two-dimensional Cartesian coordinate system. In other words, the plotted points for correction coefficients α and β are fitted with the approximate equation, and correction values for a missing data region are calculated. The approximate equation calculated as described above is a correction function.

FIG. 6 illustrates the case where α is a fixed value regardless of the value of β, and shows an average value α_{AVE} (α_{AVE}=164) of three values of α. In other words, the correction function in FIG. 6 is a constant equal to the fixed value α.

On the other hand, in FIG. 7, the plurality of points of combinations of correction coefficients α and β are curve fitted. In other words, the correction function is a quadratic function. In this case, the correction function is expressed as α=a×β²+b×β+c. In this equation, a, b, and c are constants.

As described above, the correction function is calculated from a plurality of correction coefficients α calculated in advance from the measured temperatures of each of the plurality of different materials (in the present embodiment, materials a, b, and c) and a plurality of correction coefficients β calculated in advance from the measured temperatures of each of the plurality of different materials.

Next, a method of measuring a temperature of object S by two-color thermometer 1 using the correction function calculated in advance in the above-described manner will be described. In other words, a temperature calculation method performed by temperature calculator 30 in two-color thermometer 1 will be described.

First, temperature calculator 30 calculates coefficient B (second coefficient) from a first intensity of first infrared radiation IR1 detected by first sensor 10 and a second intensity of second infrared radiation IR2 detected by second sensor 20. More specifically, coefficient B can be calculated from the relational equation I_{S}=B×I_{L}^{1.75}. In other words, coefficient B can be calculated by B=I_{S}÷I_{L}^{1.75}, where I_{S} is the first intensity of first infrared radiation IR1 (infrared radiation at a shorter wavelength) detected by first sensor 10, and I_{L} is the second intensity of second infrared radiation IR2 (infrared radiation at a longer wavelength) detected by second sensor 20.

Next, temperature calculator 30 calculates coefficient A (first coefficient) by inputting the calculated coefficient B into a correction function. More specifically, the correction function is a function of correction coefficients α and β. Correction coefficient α obtained by substituting coefficient B for correction coefficient β in the correction function is coefficient A. For example, when the correction function in FIG. 6 (α is fixed) is used, α=A. Moreover, when the correction function of the quadratic function determined in FIG. 7 is used, coefficient A is calculated by substituting coefficient B for correction coefficient β in the quadratic function.

Next, temperature calculator 30 calculates temperature T of object S based on intensity ratio Rate, which is a ratio between the first intensity of first infrared radiation IR1 detected by first sensor 10 and the second intensity of second infrared radiation IR2 detected by second sensor 20, and coefficient A (first coefficient) calculated by the correction function. More specifically, temperature T can be calculated by the relational equation T (° C.)=A×(Rate)^{0.38}.

Here, the intensity ratio Rate is expressed by the relational equation Rate=I_{S}/I_{L}, where I_{S} is the first intensity of first infrared radiation IR1, which is shorter wavelength infrared radiation, I_{L} is the second intensity of second infrared radiation IR2, which is longer wavelength infrared radiation, and Rate is the intensity ratio between first intensity I_{S} of first infrared radiation IR1 and second intensity I_{L} of second infrared radiation IR2. Therefore, temperature T can be calculated by T=A×(I_{S}/I_{L})^{0.38}. In other words, temperature T can be calculated by substituting the calculated coefficient A, intensity I_{S} detected by first sensor 10, and intensity I_{L} detected by second sensor 20 into T=A×(I_{S}/I_{L})^{0.38}.

In the above-described manner, temperature calculator 30 can calculate temperature T of object S using the first intensity of first infrared radiation IR1 detected by first sensor 10 and the second intensity of second infrared radiation IR2 detected by second sensor 20.

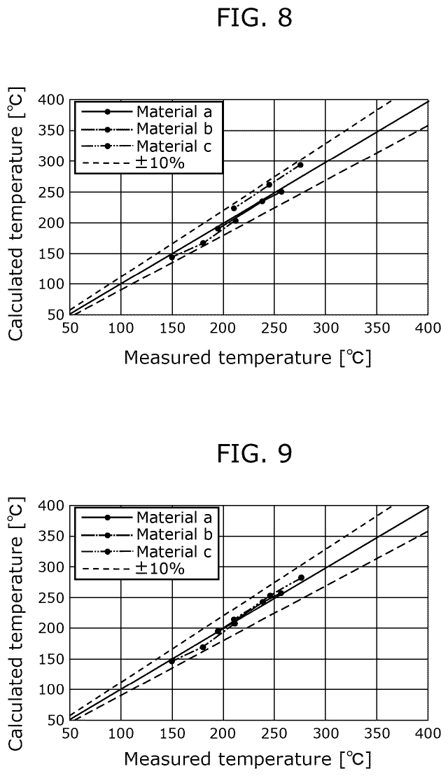

Note that the results of comparison between the temperatures calculated in the above-described manner (calculated temperatures) and the temperatures actually measured (measured temperatures) are illustrated in FIG. 8 and FIG. 9. FIG. 8 illustrates the result when the correction function (α is fixed) in FIG. 6 is used as the correction function. FIG. 9 illustrates the result when the quadratic function determined in FIG. 7 is used as the correction function.

As illustrated in FIG. 8 and FIG. 9, the temperatures of the objects can be measured more accurately when the quadratic function is used as the correction function. In other words, correction coefficients α and β can be approximated and corrected more accurately when correction coefficients α and β obtained by actual measurement are fitted with the quadratic function. As described above, a quadratic function may be used as the correction function to be used when temperature calculator 30 calculates a temperature.

As described above, two-color thermometer 1 according to the present embodiment includes: first sensor 10 that detects a first intensity that is an intensity of first infrared radiation IR1 emitted by object S; second sensor 20 that detects a second intensity that is an intensity of second infrared radiation IR2 emitted by object S at a wavelength different from a wavelength of first infrared radiation IR1; and temperature calculator 30 that calculates coefficient A (a first coefficient) by inputting, into a correction function, coefficient B (a second coefficient) calculated from the first intensity detected by first sensor 10 and the second intensity detected by second sensor 20, and calculates a temperature of object S based on coefficient A calculated and an intensity ratio between the first intensity detected by first sensor 10 and the second intensity detected by second sensor 20. Furthermore, in two-color thermometer 1 according to the present embodiment, the correction function to be used for calculating a temperature by temperature calculator 30 is calculated from correction coefficients α and β calculated in advance from a measured temperature of each of a plurality of different materials.

As described above, two-color thermometer 1 according to the present embodiment corrects the temperature by not only using the intensity ratio of infrared radiation at two different wavelengths, but also determining a correction function in advance based on measured temperatures of materials and calculating coefficients by the correction function. In other words, the temperature is corrected by considering information on the intensities of infrared radiation (emissivity) that differ according to the properties of materials. With this, the temperature of object S can be measured with high accuracy.

In addition, two-color thermometer 1 according to the present embodiment can shorten the processing time for temperature calculation. Therefore, the time required for adjusting the output of a laser beam by temperature feedback correction unit 4 can be shortened. For example, the processing time is 10 ms or less, which is a sum of the time for measuring the temperature by two-color thermometer 1 and the time for determining the laser output value by temperature feedback correction unit 4 after the measurement.

Moreover, the techniques according to the present disclosure can be implemented as a temperature measurement method. More specifically, a temperature measurement method according to the present embodiment is a temperature measurement method of measuring a temperature of object S that emits first infrared radiation IR1 and second infrared radiation IR2 at a wavelength different from a wavelength of first infrared radiation IR1, the temperature measurement method includes: calculating coefficient A (a first coefficient) by inputting, into a correction function, coefficient B (a second coefficient) calculated from a first intensity that is an intensity of first infrared radiation IR1 detected by first sensor 10 and a second intensity that is an intensity of second infrared radiation IR2 detected by second sensor 20, and calculating the temperature of object S based on coefficient A calculated and an intensity ratio between the first intensity detected by first sensor 10 and the second intensity detected by second sensor 20. Furthermore, in the temperature measurement method according to the present embodiment, the correction function is calculated from correction coefficients α and β calculated in advance from a measured temperature of each of a plurality of different materials.

As described above, the temperature measurement method according to the present embodiment also corrects the temperature using the correction function calculated in advance based on the measured temperatures of materials, and thus can measure the temperature of object S with high accuracy.

### Variations

The foregoing has described the techniques of the present disclosure based on the embodiment, but the present disclosure should not be construed to be limited to the present embodiment.

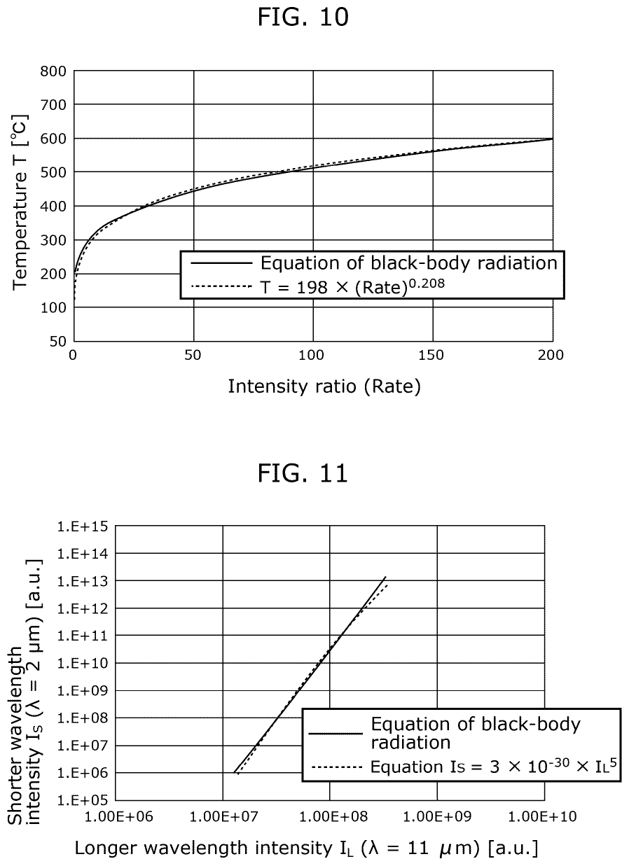

For example, in the above-described embodiment, when correction coefficients α and β are calculated, the wavelength of the shorter wavelength infrared radiation is 2 μm and the wavelength of the longer wavelength infrared radiation is 3.5 μm, but the present disclosure is not limited to this example. For example, the wavelength of the shorter wavelength infrared radiation may be 2 μm and the wavelength of the longer wavelength infrared radiation may be 11 μm to calculate correction coefficients α and β. As illustrated in FIG. 10 and FIG. 11, when the combination of wavelengths of 2 μm and 11 μm is used, coefficient A is set to 198, and the approximate equation T (° C.)=198×(Rate)^{0.208} is used, and also coefficient B is set to 3×10⁻³⁰ and the approximate equation I_{S}=3×10⁻³⁰×I_{L}⁵ is used, the resulting values can be approximated to the values obtained from the equation of black-body radiation. In other words, temperature T can be expressed by an exponential function of Rate, where A is used as a coefficient, and I_{S} can be expressed by an exponential function of I_{L}, where B is used as a coefficient. Note that in FIG. 10 and FIG. 11, a black body is used as a material.

Moreover, in the above-described embodiment, since the temperature is measured and infrared radiation intensities are measured using black anodized aluminum as material a, solder as material b, and copper as material c to calculate correction coefficients α and β, the temperature measurement range of two-color thermometer 1 is at least 0 degrees Celsius and at most 600 degrees Celsius, but the present disclosure should not be construed to be not limited to this range. For example, the temperature measurement range of by two-color thermometer 1 may be at least 0 degrees Celsius and at most 2000 degrees Celsius.

Moreover, the temperature measurement method in the above-described embodiment may be implemented as a computer program achieved by a computer, or a computer-readable recording medium in which the program is stored. For example, the present disclosure may be a program that causes a computer to execute the temperature measurement method.

Note that, other than the above, the scope of the present disclosure may encompass embodiments as a result of making, to the above-described embodiment, various modifications that may be conceived by those skilled in the art, and embodiments achieved by combining one or more structural elements in any manner in the above-described embodiment, as long as the resultant embodiments do not depart from the scope of the present disclosure. Moreover, the present disclosure may also encompass combinations of any two or more claims from among the plurality of claims set forth in the claims at the time of filing the present application, within the scope in which the combinations of the claims do not technically conflict with one another. For example, when the dependency of the claims in the claims at the time of filing the present application is changed to include multiple dependent claims or multiple dependent claims depending from any other multiple dependent claims to depend from all of the generic claims within the scope in which they are not technically conflict with one another, the present disclosure also includes combinations of all the claims included in one or more multiple dependent claims or multiple dependent claims depending from any other multiple dependent claims.

### INDUSTRIAL APPLICABILITY

The techniques according to the present disclosure are useful as, for example, a thermometer or a temperature measurement method that measures the temperature of an object.

1. A two-color thermometer comprising:
a first sensor that detects a first intensity that is an intensity of first infrared radiation emitted by an object;
a second sensor that detects a second intensity that is an intensity of second infrared radiation emitted by the object at a wavelength different from a wavelength of the first infrared radiation; and
a temperature calculator that calculates a first coefficient by inputting, into a correction function, a second coefficient calculated from the first intensity detected by the first sensor and the second intensity detected by the second sensor, and calculates a temperature of the object based on the first coefficient calculated and an intensity ratio between the first intensity detected by the first sensor and the second intensity detected by the second sensor, wherein
the correction function is calculated from a first correction coefficient calculated in advance from a measured temperature of each of a plurality of different materials and a second correction coefficient calculated in advance from the measured temperature of each of the plurality of different materials.

2. The two-color thermometer according to claim 1, wherein
the correction function is an approximate equation calculated from a plurality of plotted points of combinations of first correction coefficients and second correction coefficients in a two-dimensional Cartesian coordinate system, the first correction coefficients each being the first correction coefficient, the second correction coefficients each being the second correction coefficient.

3. The two-color thermometer according to claim 2, wherein
the correction function is a quadratic function expressed as α=a×β²+b×β+c, where α is the first correction coefficient and β is the second correction coefficient.

4. The two-color thermometer according to claim 2, wherein
the first correction coefficient is calculated in advance by a relational equation between an intensity of first infrared radiation and an intensity of second infrared radiation of each of the plurality of different materials, the first infrared radiation and the second infrared radiation being emitted by each of the plurality of different materials when the measured temperature is observed, and
the second correction coefficient is calculated in advance by a relational equation between the measured temperature and the intensity ratio between the intensity of the first infrared radiation and the intensity of the second infrared radiation of each of the plurality of different materials, the first infrared radiation and the second infrared radiation being emitted by each of the plurality of different materials when the measured temperature is observed.

5. The two-color thermometer according to claim 1, wherein
the wavelength of the first infrared radiation is shorter than the wavelength of the second infrared radiation, and
Rate=I_{S}/I_{L}, where I_{S} is the intensity of the first infrared radiation, I_{L} is the intensity of the second infrared radiation, and Rate is the intensity ratio between the intensity of the first infrared radiation and the intensity of the second infrared radiation.

6. The two-color thermometer according to claim 1, wherein
a temperature measurement range of the two-color thermometer is at least 0 degrees Celsius and at most 600 degrees Celsius.

7. A laser system comprising:
a laser device that outputs a laser beam to irradiate an object with the laser beam; and
the two-color thermometer according to claim 1, wherein
the two-color thermometer measures a temperature of the object.

8. The laser system according to claim 7, wherein
the laser system further adjusts output of the laser beam based on the temperature of the object calculated by the two-color thermometer.

9. A temperature measurement method of measuring a temperature of an object that emits first infrared radiation and second infrared radiation at a wavelength different from a wavelength of the first infrared radiation, the temperature measurement method comprising:
calculating a first coefficient by inputting, into a correction function, a second coefficient calculated from a first intensity that is an intensity of the first infrared radiation detected by a first sensor and a second intensity that is an intensity of the second infrared radiation detected by a second sensor, and calculating the temperature of the object based on the first coefficient calculated and an intensity ratio between the first intensity detected by the first sensor and the second intensity detected by the second sensor, wherein
the correction function is calculated from a first correction coefficient calculated in advance from a measured temperature of each of a plurality of different materials and a second correction coefficient calculated in advance from the measured temperature of each of the plurality of different materials.
